(19) United States
(12) Patent Application Publication
(10) Pub. No.: US 2016/0127708 A1
(43) Pub. Date: May 5, 2016

(54) METHOD FOR RECORDING AND PROCESSING AT LEAST ONE VIDEO SEQUENCE COMPRISING AT LEAST ONE VIDEO TRACK AND A SOUND TRACK

(71) Applicant: Michael Freudenberger, Remseck (DE)

(72) Inventors: Michael Freudenberger, Remseck (DE); Frank Roller, Herrenberg (DE)

(21) Appl. No.: 14/748,773

(22) Filed: Jun. 24, 2015

(30) Foreign Application Priority Data
Nov. 3, 2014 (DE) 10 2014 115 988.8

(51) Int. Cl. H04N 9/802; G11B 31/00; G11B 33/06; G11B 27/32

(52) U.S. Cl. CPC H04N 9/802; G11B 27/32; G11B 31/006; G11B 33/06

(57) ABSTRACT

The invention is based on a method for recording and processing at least one video sequence comprising at least one video track and a sound track, with at least one video recording device and at least one operating device. It is proposed that primarily a video signal of the video recording device is used for recording the video track of the video sequence, and primarily a sound signal of the operating device is used for recording the sound track of the video sequence.

### STATE OF THE ART

The invention relates to a method for recording and processing at least one video sequence comprising at least one video track and at least one sound track, according to the preamble of claim 1.

A method for recording and processing at least one video sequence comprising at least one video track and at least one sound track, with at least one video recording device and at least one operating device, has already been proposed.

It is the objective of the invention to provide in particular a generic method by which video sequences can be recorded with a particularly high sound quality. The objective is achieved according to the invention by the features of patent claim 1, while advantageous implementations and further developments of the invention may be gathered from the subclaims.

### ADVANTAGES OF THE INVENTION

The invention is based on a method for recording and processing at least one video sequence comprising at least one video track and at least one sound track, with at least one video recording device and at least one operating device.

It is proposed that primarily a video signal of the video recording device is used for recording the video track of the video sequence and that primarily a sound signal of the operating device is used for recording the sound track of the video sequence.

A “video recording device” is to be understood, in this context, in particular as a device provided to record images in the form of electrical signals. Preferably the video recording device comprises to this purpose at least one video camera. In particular the video recording device is provided for the recording of moving images. The video recording device can itself store the moving video images or can preferably send them to a further device for storage. The video recording device can in particular be embodied as a photo and/or video camera, a webcam, a smart TV, a tablet computer or a smartphone. The video sequence can preferentially be encoded and stored in a container format known to the person skilled in the art, e.g. “avi”, “mov”, “mkv” or “mp4”. The video track can be stored by means of a suitable video codec, e.g. MPEG-4, DivX. The audio track can in particular be encoded and stored by means of a suitable audio codec, e.g. WAV, MP3, AAC. The container format can contain the encoded video track and audio track. The person skilled in the art will determine a suitable storage format for the video track and audio track.

An “operating device” is to be understood, in this context, in particular as a device which is provided at least for operating the video recording device. Preferentially the operating device is embodied as a hand-controlled operating device. Preferentially the operating device is provided to be held by a user with one hand during an operating procedure. The operating device can be embodied in particular as a smartphone, a tablet computer or a laptop computer. A “smartphone” is to be understood, in this context, in particular as a touch-screen computer having a telephony function. Preferably the touch-screen of the smartphone has a screen diagonal of less than 7″. A “tablet computer” is to be understood, in this context, in particular as a touch-screen computer having a screen diagonal of at least 7″. In particular the operating device comprises at least one microphone that is provided for an audio recording.

Preferably the operating device and the video recording device are connected via a data connection. Especially preferentially the data connection is implemented wireless. In particular the operating device and the video recording device can be connected via a wireless Bluetooth data connection or WLAN data connection. The data connection can in particular be provided for exchanging image signals and/or sound signals and/or control commands between the operating device and the video recording device. The operating device and the video recording device can be connected via a direct data connection. By a “direct” data connection is to be understood, in this context, a data connection that is established between the operating device and the video recording device directly, without further intermediary devices. A direct data connection can be embodied in particular as a Bluetooth data connection or as an ad-hoc WLAN data connection. The connection can be independent from further network infrastructure. Preferably the operating device and the video recording device can be connected via further devices. In particular the operating device and the video recording device can be connected by independent access points via the Internet, or they can be connected, via a network router, with a local network that is preferentially connected to the Internet. The operating device and the video recording device can exchange data with each other and with further devices and/or services, which are connected to the local network and/or to the Internet.

A “video sequence” is to be understood, in this context, in particular as a video recording which has been recorded in one shot, especially in one single shot, i.e. in one recording sequence. Preferably a plurality of video sequences and/or sections of a plurality of video sequences can be cut to a video film. The video film can in particular comprise a plurality of shots and/or video sequences. Preferably the video sequence can comprise a recording of the user. The user can by means of the method especially easily record video sequences of himself. In particular, the user can control the recording of the video sequences via the operating device, while the video recording device records video sequences of the user. A support of the user by further persons can be dispensed with. The video sequence can preferably be provided to be published in an online service, e.g. in particular a social network and/or a job application platform. Further fields of using the video sequence or the video film comprising video sequences are conceivable, e.g. in particular marketing and/or sales schoolings, education videos in particular for online education programs and company communication. The user can determine further expedient fields of using the video sequences.

In a recording of a video sequence comprising at least one video track and at least one sound track, in particular the video track and/or the sound track of the video sequence is stored by means of a storage unit. Preferentially the storage unit can be part of the operating device. By a “primary use of a video signal” is to be understood, in this context, in particular that the video information is mainly generated on the basis of the video signal of the video recording device. “Mainly” is to mean, in this context, that at least more than 50%, preferably more than 80%, particularly preferably 100% of the video information of the video track are generated on the basis of the primary video signal. In particular for image-in-image fade-ins of further perspectives it may be possible that video signals of further video cameras generate portions of the video information of the video track.

By a “primary use of a sound signal” is to be understood, in this context, in particular that the sound information is mainly generated on the basis of the sound signal of the operating device. “Mainly” is to mean, in this context, that at least more than 50%, preferably more than 80% of the sound information of the sound track are generated from the primary sound signal.

The sound signal can advantageously be recorded during the recording of the video sequence particularly close to the user. A quality of the sound signal and/or of the sound track can advantageously be especially high.

Further it is proposed that for recording the sound track, to the purpose of suppressing environment noise, a sound signal of the video recording device is processed in addition to the sound signal of the operating device. In particular the sound signal of the video recording device can be used to capture environment noises or interference noises. By additionally processing the sound signal of the video recording device, environment noises or interference noises can advantageously be reduced when the sound track is recorded. Advantageously a high quality of the sound track of the video sequence is achievable.

It is moreover proposed that, in particular for recording video sequences comprising recordings of several users, a plurality of operating devices is used. Preferably to each user an operating device can be allocated. Preferably primarily the sound signals of the operating devices of the users can be used for the sound recording. If during the recording of the video sequence the users speak alternately, the sound signal of the operating device which is nearest to the user who is speaking and/or is allocated to the user who is speaking can be used as a primary sound signal. The sound signals of the further operating devices and/or the sound signal of the video recording device are preferably usable for suppressing environment noises or interference noises.

It is proposed that in the recording of the sound track, microphone characteristics of the operating device and/or of the video recording device and/or characteristics of a voice of the user speaking and/or characteristics of a recording room are taken into account. In particular frequency responses of the operating device and/or of the video recording device, a voice type of the voices and/or reflections of the recording room can be considered. The sound signal can be subsequently processed and/or corrected. A frequency response correction of the sound signal can be effected. In particular frequency ranges can be toned up and/or down. Harmonic overtones can be toned up and/or added.

In particular linear overtones can be added to the sound signal by means of an “enhancer”. A compression of the sound signal can be effected. Differences in sound volume can be kept advantageously low. Resonance effects can be kept advantageously low. An intelligibility of recorded speech can be improved with respect to an unprocessed sound signal of the operating device.

It is further proposed that, when the video recording device is set up, a set-up angle of the video recording device is signaled to a user.

By a “set-up angle”, in this context, in particular an angle is to be understood, which is included by an optical axis of the video camera integrated in the video recording device, by which the video sequence is recorded, and a horizontal plane. Preferentially the set-up angle is less than 15°, particularly preferably less than 5°. Preferably the video recording device comprises at least one tilt sensor. In particular the tilt sensor can be provided to capture the set-up angle by measuring a direction of a gravity vector.

Preferentially the set-up angle can be visually signaled to a user on a screen of the video recording device that faces the user. The user can particularly easily perceive the screen facing him with a view direction towards the video recording device. As an alternative, a screen of the operating device can be used for visualizing the set-up angle. The visualization of the set-up angle on the screen of the operating device can be in particular advantageous in case the video recording device does not comprise a screen that faces the user. The visualization can be effected by means of a symbolized water level and/or by a numeric indication of the set-up angle. Preferentially the visualization may comprise symbolic colors, in particular the color “green” for a set-up with a preferred set-up angle, “Yellow” for a set-up with a deviation of less than 5° from the preferred set-up angle and “red” for a deviation of more than 5° from the preferred set-up angle. The user can particularly easily recognize an advantageous set-up angle. An erroneous set-up can be advantageously avoided or a probability of an erroneous set-up can be kept low.

It is proposed that the video signal of the video recording device is evaluated to determine a subject position of an image section. A “subject position” is to mean, in this context, in particular a relative position of a principal subject within the image section. The principal subject can be, in particular, the user recording a video sequence of himself. It is possible that several principal subjects, in particular several users, are arranged in the image section. Preferably the subject position can comprise information about positions of subject parts, in particular a position of a head, of eyes, mouth and shoulders of the user. An advantageous set-up of the video recording device and/or an advantageous position of the subject with respect to the video recording device can be advantageously identified.

Especially advantageously the user is signaled an optimum subject position within the image section. In particular a deviation of the determined subject position from the optimum subject position can be signaled to the user. The user can correct the subject position. It can advantageously be ensured that the subject position of the recorded video sequence is at least close to the optimum subject position. A visual enhancement of the video sequence can be particularly advantageous.

It is proposed that the video signal of the video recording device is evaluated to determine a preferred set-up location of the video recording device and/or a preferred subject recording location. In particular the video recording device can be pivoted about an axis that is perpendicular to a ground of the recording room by an angle, in particular 360°, while the video signal is recorded for the purpose of determining the preferred set-up location of the video recording device and/or the preferred subject recording location. A model of the recording room can be calculated. In particular light incidence, back-lighting and rear-lighting situations as well as a background of the subject can be evaluated.

Depending on light incidence and/or on a background of the subject, the preferred set-up location of the video recording device and/or the preferred subject recording location can be determined. Preferably the system can give the user indications for improving recording conditions at the subject recording location, e.g. modifications of the light incidence by opening and/or closing blinds and/or curtains and/or by setting up and/or shifting lamps and/or further light sources. Furthermore the video signal of the operating device can be evaluated to determine a preferred set-up location of the video recording device and/or a preferred subject recording location. The user can pivot the operating device at the subject recording location with an optical axis of a video camera of the operating device in a horizontal plane, preferably by 360°, about an axis that is perpendicular to the floor of the recording room. Further information regarding the recording room can be captured.

As an alternative, the video recording device can comprise a laser scanner, or a laser scanner can be coupled with the video recording device and/or with the operating device. The laser scanner can record a 3D model of the recording room. The 3D model can be used to determine the preferred set-up location of the video recording device and/or the preferred subject recording location.

Further it is proposed that the sound signal of the operating device and/or a sound signal of the video recording device are/is evaluated to determine a preferred set-up location of the video recording device and/or a preferred subject recording location. In particular, the operating device and/or the video recording device can output a test sound, which is recorded by the operating device or by the video recording device, preferably by the operating device and the video recording device. Preferentially a run-time of the test sound from the video recording device to the operating device and/or from the operating device to the video recording device can be evaluated. A distance of the video recording device from the operating device can advantageously be determined. Preferably sound reflections and/or environment noises of the recording room can be recorded by the video recording device and/or by the operating device. The subject recording location can be chosen such as to advantageously allow a recording of the sound track which has as little sound reflexion and/or environment noise as possible. Preferably, for the purpose of determining the preferred set-up location of the video recording device and/or of a preferred subject recording location, acoustical characteristics of the recording room determined on the basis of sound signals and optical characteristics of the recording room determined by video signals are evaluated. The set-up location of the video recording device and/or the preferred subject recording location can be especially suitable, optically as well as acoustically, for the recording of video sequences.

Moreover it is proposed that a screen integrated in the video recording device is used as a light source for illuminating a subject recording location. In particular, the screen of the video recording device can be orientated towards the user. The screen can advantageously illuminate the subject recording location and/or in particular the subject in the image section. Preferably a color temperature of the light radiated from the screen can be changed. Preferentially the color temperature can be adapted to a color temperature of an environment light. The video sequences can have a particularly natural effect. Color shades can be presented particularly well. A light atmosphere can be advantageously influenced. Especially preferentially an intensity and the color temperature of an image area of the screen can be locally variable. The subject can be illuminated in a particularly targeted manner. It is further proposed that the screen of the operating device is used as a further light source. The subject can be illuminated in a particularly effective way.

It is also proposed that a directed light source of the video recording device is used for lighting objects in the recording room. Light reflected by the objects can further improve the illumination of the subject. Preferably a wavelength, a radiation angle and/or a color spectrum of the directed light source can be adapted to properties of the lighted object, in particular a geometry and/or a surface characteristic of the lighted object.

It is further proposed that the user is guided by an avatar during the recording of the video sequence. An “avatar” is to be understood, in this context, in particular as a computer-animated artificial persona, in particular a face. The avatar can be modeled after a human image or can have an abstracted “cartoon” figure. The avatar can preferably be presented in a line of vision of the user during the recording of video sequences. In particular, the avatar can be displayed on the screen of the video recording device. The avatar can give the user instructions before, during and after the recording of the video sequence. For example, the avatar can provide hints regarding facial and other expression, subject position, speech speed, inflection and emphasis. The avatar can in particular provide hints for a preferred line of vision of the user. Preferably the presentation of the avatar and of an area of the screen of the video recording device surrounding the avatar can be adapted such that a light color radiated from the screen is advantageous in the whole and/or corresponds to a light color of the environment. The presentation of the avatar can have no or only little influence on the illumination of the subject recording location. The user can advantageously be guided during the recording of the video sequence. The video sequence can have a particularly advantageous effect corresponding to the desired purpose of use. The user's line of vision can be advantageously influenced. A facial expression of the user can be advantageously influenced. Necessary previous knowledge of the user regarding the recording of the video sequence can be particularly little. It is further proposed that the video signal of the video recording device and/or a video signal of the operating device is used to recognize gestures of the user for the purpose of controlling the recording of the video sequence. Preferably at least one of the video signals and at least one of the sound signals can be used to recognize gestures of the user for controlling the recording of the video sequence. In particular the gestures can instigate starting and/or stopping a video recording and/or induce a start of a new video sequence. The user can control the recording of the video sequence advantageously by gestures. In particular a line of vision and/or movements of the user's head, a body language, e.g. movements of a hand, a speaking behavior, e.g. in particular speech pauses, intonation and/or use of set phrases, e.g. greetings and/or good-byes, can be evaluated as gestures for controlling the recording of the video sequence.

Advantageously an accelerometer of the operating device can be used for controlling the recording of the video sequence and/or for operating the video recording device and/or the operating device. In particular the operating device can, in dependence on a measured acceleration, move a cursor and/or a pointer over a user interface presented on the screen of the video recording device. The accelerometer can be used to manipulate selected objects, e.g. to move image sections and/or to change play positions. The user interface can fade in command buttons, which can be selected directly at the operating device or by moving the pointer on the screen of the video recording device. The user interface can preferably be context sensitive. For example, potential functions can be faded in if a portion of a video sequence is selected. If a transition between two video sequences is selected by moving the pointer, the user can be offered cut options and/or a variety of transitions to select from. Preferably the user interface can be adapted to the user, in particular to the experience he has with the system and/or with computer systems, his age, an application area, e.g. at home or in a meeting, or to the type of video film that is to be generated. It may also be possible that the user interface is shown on a further screen. The user can control the user interface by moving the operating device. An operation by the user with a line of vision to the video recording device can be facilitated.

Furthermore it is proposed that the subject position in the image section is changed during the recording of the video sequence. In particular the principal subject can be shifted and/or enlarged and/or zoomed down in the image section during the recording of the video sequence. Preferably only a portion of the image section of the video recording device can be used for the recording of the video sequence. By shifting and/or zooming down and/or enlarging of the section, virtual tracking shots may be generated. The video sequence can have an especially dramatic impact. The subject position and/or an image section can be advantageously adapted. A “camera wobbling” and/or camera movements can be added. An impression of a hand camera can be created. The video sequence can have an especially natural effect.

Moreover it is proposed that the video sequence is evaluated regarding its effect on beholders and this evaluation is signaled to a user. The evaluation can consider in particular visual and/or acoustical characteristics. Visual characteristics can comprise in particular a distance of the subject, an orientation of body and/or face, an open or closed bearing of the body, a facial expression and gestures, e.g. nodding, and a body language. Acoustical characteristics can comprise sound pitch and phrase intonation, sound volume, speed, pauses and/or emphasizing of spoken words. Preferably the evaluation can depend on the desired application area of the video sequence. In particular, the video recording of the user may be intended to have an informal effect for sharing in a circle of friends but to transmit a best possible competence for publishing on a job application portal. Preferably evaluation standards are adapted according to the desired effect.

Furthermore it is proposed that, when a video film is made which comprises a plurality of recorded video sequences, the video sequences are selected and/or discarded and/or cut on the basis of an evaluation. “Cutting” of a video sequence is to mean, in this context, in particular that the video sequence is shortened by discarding portions of the video sequence which are not to be used for the video film. Preferably the video film can consist of a plurality of video sequences, each of which comprising a scene with predefined contents. Preferentially the contents of the scenes can be set down in a video screenplay. Preferably the user can select from a plurality of video scripts and/or create his own video script, depending on the desired utilization of the video film. Preferably the user can be requested to record a video sequence of a scene according to the video screenplay. Preferably the user can record a plurality of shots of a scene. Preferably video sequences with particularly well-done shots of the respective scene can be respectively chosen according to the evaluation. Preferably the video film can be compiled from the particularly well-done video sequences. It may also be possible that a scene is compiled from a plurality of shots of the scene. This may be especially advantageous if, in different places, the shots of the scene have deficits and/or are particularly well-done.

Furthermore, a system is proposed for generating video sequences and/or video films. The system comprises in particular at least one video recording device and at least one operating device, which are connected via a preferably wireless data connection. The system further comprises an appropriate controlling program, which is carried out by the video recording device and/or the operating device and controls the method for recording and processing the video sequence and/or for generating a video film. The system can be particularly suitable for carrying out the method described.

It is further proposed that the video recording device is implemented as a tablet computer and the operating device is implemented as a smartphone. The tablet computer can comprise an advantageously large screen, which can be particularly suitable for illuminating a motive recording location and/or for presenting an avatar. The tablet computer can be set up in an advantageous set-up angle particularly easily by means of a stand support and/or by leaning it against a wall or against an object. As an alternative, the tablet computer can be fastened to a wall bracket and/or can be fastened to and/or supported against objects. The smartphone can be held by the user particularly well in his hand. The smartphone can comprise an especially high-quality microphone.

Furthermore it is proposed that a computing unit of the operating device is provided to control the method for recording and processing the video sequence and/or for generating a video film. A further computing unit that is independent from the operating device and/or from the video recording device can be omitted. Preferably the operating device can comprise a data connection with the Internet. The operating device can store and/or publish the video sequences and/or the video film advantageously with an internet-based cloud service. The operating device can transfer computing-intensive processing procedures of the video sequences and/or of the video film to a video processing service that is connected to the Internet and/or can receive processed video sequences and/or video films from the processing service. Processing procedures may be possible which overtax a computing power of the operating device. The processing procedures can be carried out particularly quickly. The method according to the invention and/or the system for recording and processing at least one video sequence comprising at least one video recording device and at least one operating device are/is herein not to be restricted to the above-described application and implementation form. In particular, the method according to the invention and/or the system according to the invention for recording and processing at least one video sequence comprising at least one video track and a sound track by means of at least one video recording device and at least one operating device may comprise a number of method steps and of respective elements, components and units that differs from the number herein mentioned, for implementing a functionality herein mentioned.

### DRAWINGS

Further advantages may be gathered from the following description of the drawings. In the drawings four exemplary embodiments of the invention are shown. The drawings, the description, and the claims contain a plurality of features in combination. The person having ordinary skill in the art will purposefully also consider the features separately and will combine them in further expedient ways.

It is shown in:

FIG. 1 a schematic presentation of a system for executing the method according to the invention,

FIG. 2 a schematic presentation of a video film with video sequences,

FIG. 3 a further schematic view of the system,

FIG. 4 a schematic presentation of a subject recording location,

FIG. 5 a schematic presentation of method steps of the method for recording video sequences,

FIG. 6 a schematic presentation of possible system configurations,

FIG. 7 a schematic presentation of a further possible system configuration,

FIG. 8 a schematic presentation of a further possible system configuration,

FIG. 9 a schematic presentation of a further method for recording and/or processing video sequences along a timeline, and

FIG. 10 a presentation of a Contextual Overlay.

### DESCRIPTION OF THE EXEMPLARY EMBODIMENTS

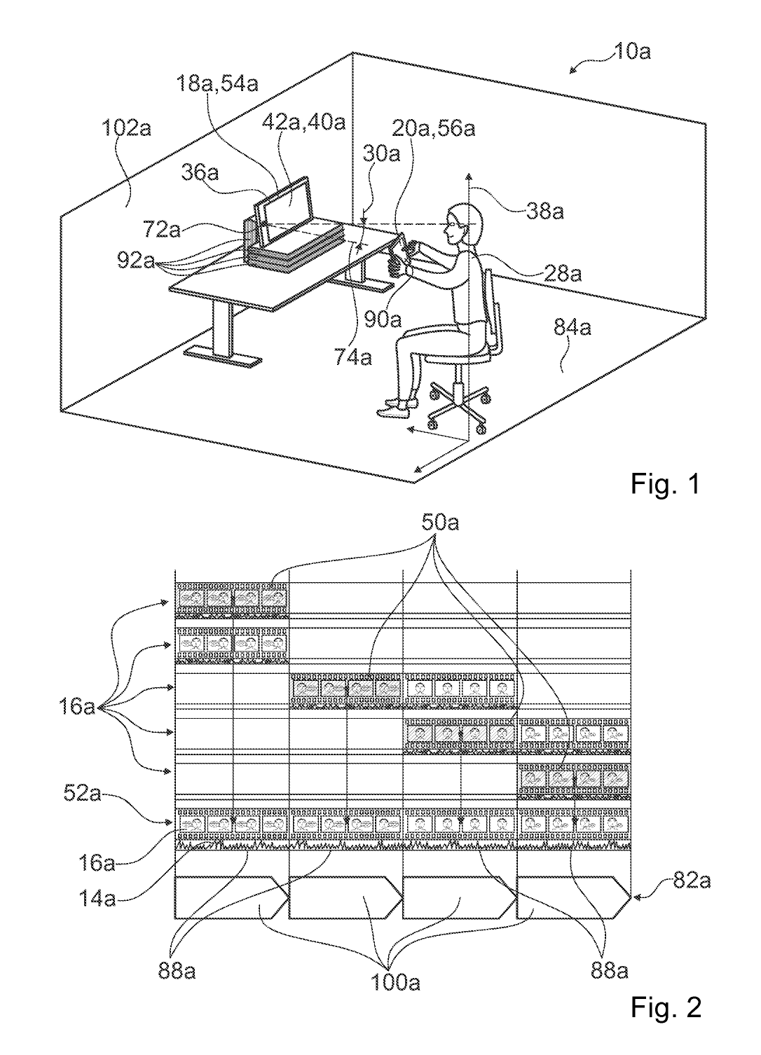

FIG. 1 shows a schematic presentation of a system 10a for carrying out the method according to the invention for recording and processing at least one video sequence 16a (FIG. 2) comprising at least one video track 12a and at least one sound track 14a in a first exemplary embodiment. Herein the method is provided for recording and processing a plurality of video sequences 16a comprising at least one video track 12a and at least one sound track 14a. The video sequences 16a are cut to a video film 52a by means of the system 10a.

The system 10a comprises a video recording device 18a, which is implemented as a tablet computer 54a. Moreover the system 10a comprises an operating device 20a, which is implemented as a smartphone 56a.

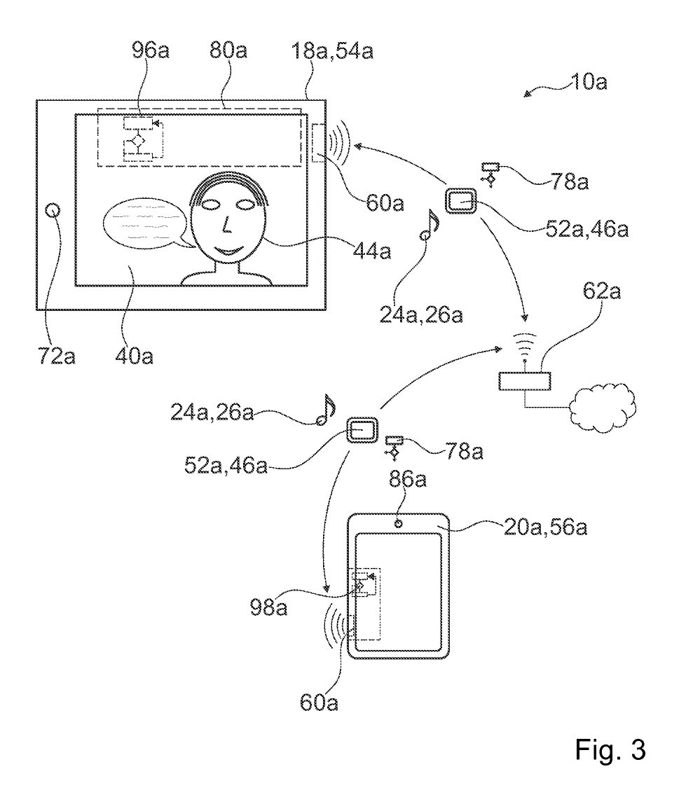

The video recording device 18a and the operating device 20a are each equipped with a WLAN radio module 60a (FIG. 3), by which they are connected to a local network 62a or directly to each other. The video recording device 18a and the operating device 20a exchange via the local network 62a data, e.g. sound signals 24a, 26a, video signals 22a, 46a and control commands 78a. As an alternative, in particular in case there is no local network, the video recording device 18a and the operating device 20a can also be connected via a Bluetooth connection or another suitable data connection.

A computing unit 80a of the video recording device 18a carries out a controlling program 64a of the video recording device 18a, and a computing unit 58a of the operating device 20a carries out a controlling program 66a of the operating device 20a. The controlling program 64a of the video recording device 18a and the controlling program 66a of the operating device 20a are equipped with the functions necessary for carrying out the method. The controlling program 66a of the operating device 20a that is executed by the computing unit 58a of the operating device 20a is embodied as a master application which is provided to control the method for recording and processing the video sequence 16a and/or for generating the video film 52a.

The system 10a is in particular provided for recording and processing video sequences 16a of a user 28a, which are to be combined to the video film 52a as well as to be stored and retrieved in an internet-based social network and/or an internet-based job application platform. The controlling program 66a of the operating device 20a provides the user 28a with a plurality of templates 82a, each of which comprise a script with instructions for several scenes 68a of the video film 52a.

For preparing the recording of video sequences 16a the user 28a first of all sets up the video recording device 18a such that it is stationary in a recording room 70a or at a recording location.

To this purpose the user 28a sets the system 10a into a set-up mode by means of the operating device 20a and moves himself with the video recording device 18a approximately in a center of the recording room 70a. Then the user 28a moves the video recording device 18a once by 360° about an axis that is perpendicular to a floor 84a of the recording room 70a, wherein the user 28a moves the video recording device 18a in such a way that an optical axis 74a of a video camera 72a of the video recording device 18a includes with a horizontal plane that is parallel to the floor 84a of the recording room 70a angles of less than 20° during the movement. The video signal 22a of the video recording device 18a is transmitted to the operating device 20a and is evaluated by the controlling program 66a of the operating device 20a. The controlling program 66a of the operating device 20a calculates on the basis of the video signal 22a a 3D model of the recording room 70a comprising light conditions and possible subject backgrounds. In particular the controlling program 66a of the operating device 20a evaluates a light incidence onto the user 28a. Furthermore a sound signal 24a of the operating device 20a and a sound signal 26a of the video recording device 18a are evaluated by the controlling program 66a of the operating device 20a, to the purpose of detecting room reflections. Additionally the user 28a can rotate the operating device 20a also by 360° about an axis that is perpendicular to the floor 84a. A video camera 86a of the operating device 20a films the recording room 70a from a position in which the user 28a with the operating device 20a is located.

The controlling program 66a of the operating device 20a determines on the basis of this information a preferred set-up location 36a of the video recording device 18a and a preferred subject recording location 38a, and provides indications how to improve light conditions at the subject recording location 38a. The user 28a may, for example, following an instruction from the system 10a, adapt a room lighting by opening or closing blinds and/or by positioning additional light sources. In an operating mode the user 28a pivots the operating device 20a in different directions in the recording room 70a. The controlling program 66a of the operating device 20a shows on a screen 90a of the operating device 20a, in real time, a picture of the recording room 70a recorded by means of the video camera 86a of the operating device 20a, and fades possible set-up locations 36a of the video recording device 18a into this picture, e.g. by graphically visualizing the video recording device 18a in these locations. As an alternative, the user 28a can also pivot the video recording device 18a in the recording room 70a and/or the picture of the recording room 70a can be visualized in real time on the screen 40a of the video recording device 18a. Preferably in this case the recording room 70a is recorded by means of a video camera 72a arranged at a rear side of the video recording device 18a. Furthermore the controlling program 66a of the operating device 20a identifies, by means of image recognition algorithms, objects 92a, e.g. books or the like, which can be utilized for setting up the video recording device 18a at the possible set-up locations 36a. The objects 92a are indicated to the user 28a in list form and/or are visualized at the set-up locations 36a together with the video recording device 18a.

The system 10a gives hints regarding the preferred set-up location 36a to the user 28a on a screen 40a of the video recording device 18a, and the user 28a sets up the video recording device 18a at the set-up location 36a. During set-up of the video recording device 18a the user 28a is signaled a set-up angle 30a of the video recording device 18a. The set-up angle 30a is determined by means of angle-measuring apparatuses of the video recording device 18a, which capture an angle that is included by the optical axis 74a of the video camera 72a and a horizontal plane that is perpendicular to the gravitational force. The set-up angle 30a should preferably deviate from the horizontal plane by less than 5°. The smaller the set-up angle 30a, the more a color shifts from “red” over “yellow” to “green” on a control display shown on the screen 40a. The user 28a can thus particularly easily recognize a correct set-up of the video recording device 18a.

The user 28a then positions himself at the subject recording location 38a. The controlling program 66a of the operating device 20a now evaluates the video signal 22a of the video recording device 18a to determine a subject position 32a within an image section 34a. In particular the controlling program 66a of the operating device 20a determines positions of eyes, nose, mouth and shoulders of the user 28a. An optimum subject position 32a within the image section 34a is signaled to the user 28a on the screen 40a by a frame. The user 28a shifts his position within the subject recording location 38a in such a way that his head is inside the frame. When the optimum subject position 32a is determined, features of the user 28a, e.g. his height, hairdress, clothing or body type, are taken into account.

The screen 40a integrated in the video recording device 18a serves in the recording of the video sequences 16a as a light source 42a for an illumination of the subject recording location 38a. The controlling program 66a of the operating device 20a ensures to this purpose that a color temperature of the light radiated from the screen 40a has a desired color temperature that is adapted to an environment lighting, independently from interface elements shown on the screen 40a.

During the recording of the video sequences 16a, the user 28a is guided by an avatar 44a, which is embodied by an animated character having an abstract cartoon shape. The avatar 44a is controlled by the controlling program 66a of the operating device 20a and is presented on the screen 40a. The avatar 44a briefs the user 28a into the scene 68 that is to be recorded, in particular the avatar 44a provides instructions regarding contents and desired gestures.

The user 28a starts the recording of the video sequence 16a by a gesture, e.g. a movement of a hand, or by direct eye contact with the video camera 72a. The gestures of the user 28a are captured by means of the video signal 22a of the video recording device 18a and by means of the video signal 46a of the further video camera 86a, which is part of the operating device 20a, and are evaluated as well as identified by the controlling program 66a of the operating device 20a. The controlling program 66a of the operating device 20a perceives, inter alia, if the user 28a is looking in towards the video camera 72a or not, if he is speaking, if he is moving his body, if he is looking in a direction towards a screen 90a of the operating device 20a, or if he is gesturing with his hands. When the user 28a starts a new recording, the controlling program 66a of the operating device 20a carries out a countdown to zero, the actual recording of the video sequence 16a starting at the moment of zero. If the video sequence 16a is intended to directly follow an existing video sequence 16a, the controlling program 66a of the operating device 20a shows in the countdown period the end of the previous video sequence 16a to facilitate for the user 28a a seamless recording of the following video sequence 16a. Additionally or as an alternative, the sound track 14a of the previous video sequence 16a is played. Furthermore contents are shown of the scene 68a that is to be recorded, and the desired subject position 32a is visualized. During the recording the avatar 44a continuously provides the user 28a with instructions determined by the controlling program 66a of the operating device 20a, how to improve his behavior and/or his gesturing during the recording. For example, the avatar 44a is able to express emotions and to adapt these to a behavior of the user 28a. If the user 28a applies an advantageous gesturing, the avatar 44a can have a laughing face. In addition, the controlling program 66a of the operating device 20a visualizes abstract characters, e.g. a matchstick figure, for illustrating the body carriage of the user 28a to the user 28a. Different aspects of the gesturing and of the behavior of the user 28a, e.g. a speech velocity, are visualized by the controlling program 66a of the operating device 20a in form of bar charts. In case a plurality of video sequences 16a are recorded or partial sections of a video sequence 16a are re-recorded, the user 28a is shown, e.g. by colors like “green” for well done or “red” for badly done, how well his behavior corresponds to the intersections with the previous or the following recording.

In an alternative operation mode, during the recording of the video sequence 16a a static image of the user 28a is shown on the screen 40a by the controlling program 66a of the operating device 20a instead of the avatar 44a. The user 28a can fixate eyes of the image of himself, and can thus keep to an advantageous view direction. As an alternative, an arrow or a similar symbol is shown on the screen 40a, which indicates an advantageous view direction to the user 28a. A remaining area of the screen 40a can remain dark or can light up in case the screen 40a is to be used as a light source 42a. In a further operation mode, the screen 40a serves as a teleprompter, i.e. the user 28a is shown a ready-phrased text compiled before the recording of the video sequence 16a, which is then read by the user 28a. As an alternative, key words regarding the content of the video sequence 16a can be shown to the user, which he then reads ad-hoc.

In the recording of the video track 12a of the video sequence 16a primarily the video signal 22a of the video recording device 18a is used. Herein a cut-out 76a of the image section 34a of the video signal 22a is recorded on the video track 12a. The controlling program 66a of the operating device 20a shifts the cut-out 76a within the image section 34a and modifies its enlargement rate, to the purpose of achieving in the recorded video sequence 16a an impression of camera sweeps as well as of the image being zoomed in and out.

In the recording of the sound track 14a of the video sequence 16a primarily the sound signal 24a of the operating device 20a is used. In addition, the sound signal 26a of the video recording device 18a is processed. The controlling program 66a of the operating device 20a compares the sound signals 24a, 26a and filters out environment noise and interference noise, which have with respect to a voice of the user 28a a greater loudness in the sound signal 26a of the video recording device 18a, which has a greater distance from the user 28a, than they have in the sound signal 24a of the operating device 20a. The quality of the sound track 14a, in particular a speech comprehensibility, is thus enhanceable.

After the recording, the controlling program 66a of the operating device 20a evaluates the video sequences 16a, on the basis of a criteria catalog, regarding their effect on a viewer.

A resulting evaluation 50a is signaled to the user 28a on the screen 40a. In the exemplary embodiment (FIG. 2) evaluations 50a for portions 88a of the video sequences 16a, which respectively correspond to a scene 68a of the video film 52a, are indicated to the user 28a. The same scene 68a can be recorded several times by the user 28a and be contained in several video sequences 16a. The evaluation 50a corresponds to a marking of those portions 88a which are suggested to be used for generating the video film 52a. The user 28a can adopt this suggestion or can suggest a different portion 88a. In a further operation mode, the controlling program 66a evaluates the video sequences 16a sectionally. The user 28a can, in case of a negative evalutation 50a of portions of the video sequences 16a, record these sections once again or can substitute them by portions of further video sequences 16a.

In a following step the video film 52a is published by the operating device 20a via the local network 62a or, as an alternative, is published in an online service, e.g. a social network or a job application platform, via a mobile phone connection.

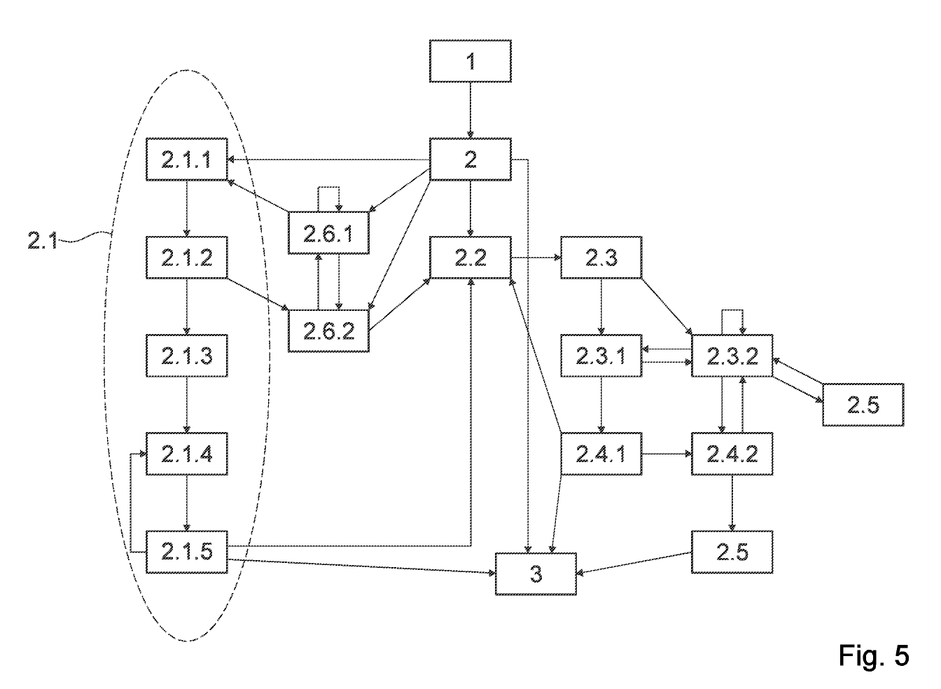

FIG. 5 shows a preferred version of method steps of the method for recording video sequences 16a in the system 10a, as an example. The method steps are executed by the computing unit 58a of the operating device 20a and are controlled by the controlling program 66a of the operating device 20a.

In a first step 1 a data structure for a new video is created.

In a step 2 a first video sequence 16a is recorded, which can comprise one scene 68a or a plurality of scenes 68a. If only the first scene 68a is to be recorded, and only recorded once, a video film 52a comprising the video sequence 16a is stored and finished in a step 3.

As an alternative, in a step 2.6.1 further shots of the scene 68a are taken. The recorded scenes 68a can be viewed and evaluated by the user 28a in a step 2.6.2.

As an alternative, following step 2 or step 2.6.1, a weakness analysis workflow 2.1 is called up.

In a step 2.1.1 the scene 68a is analyzed for weaknesses and is provided with evaluations 50a. In a step 2.1.2 the user 28a can modify the evaluations 50a.

In a step 2.1.3 a re-recording of a portion of the scene 68a in which the weakness was identified is prepared. To this purpose a portion of the sound track 14a and/or of the video track 12a of the scene 68a directly preceding the portion having the weakness is played to the user 28a. Furthermore, context information from the script of the scene 68a, e.g. contents of the scene 68a, is faded in for the user 28a. By such information an easy access into the portion of the scene 68a that is to be re-recorded is available to the user 28a.

In a step 2.1.4 the section in which the weaknesses were identified is re-recorded. The user 28a can confirm or modify cut points which have been automatically set. After this the re-recorded section is inserted into the scene 68a.

In a step 2.1.5 the scene 68a with the re-recorded section is re-analyzed for weaknesses. If further weaknesses are found, step 2.1.4 is repeated.

If no further shots of the scene 68 are to be recorded and/or no further portions of the scene 68a are to be re-recorded, in a step 2.2 a cut point is marked at which a following scene 68a can be added. As an alternative, if there is no next scene 68a that is to be filmed, the video film 52a is stored and completed in step 3.

If there are further scenes 68a that are to be filmed, step 2.2 is followed by step 2.3, in which a further scene 68a is filmed, which is added at the cut point determined in step 2.2.

In a step 2.3.2, further shots of the further scene 68a can be recorded. As an alternative or additionally, already stored video sequences 16a can be examined whether they can be utilized for the current scene 68a, and/or can be used.

In a step 2.3.1 the cuts of the scenes 68a are checked. Step 2.3.1 can be executed following step 2.3 or step 2.3.2.

In a step 2.4.1 the scene 68a is checked for weaknesses, if applicable the weakness analysis workflow 2.1 may follow here.

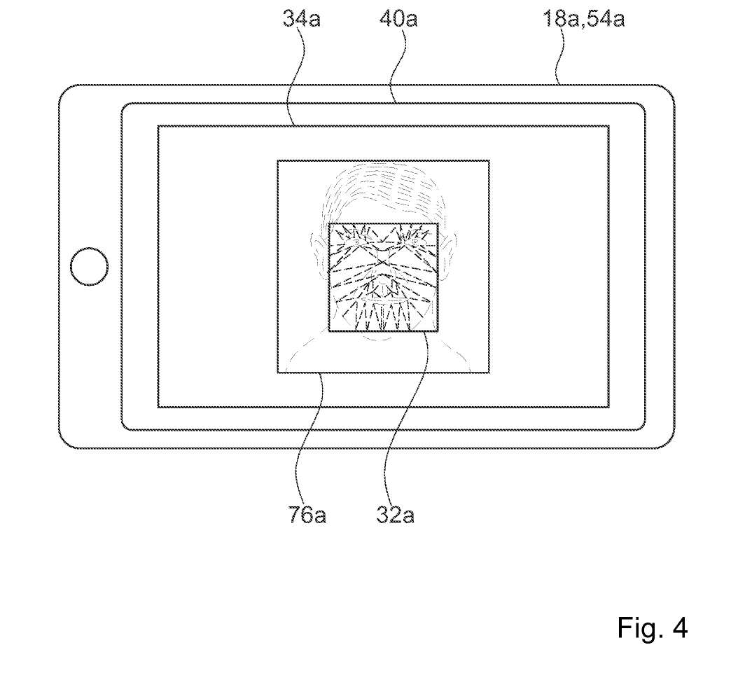

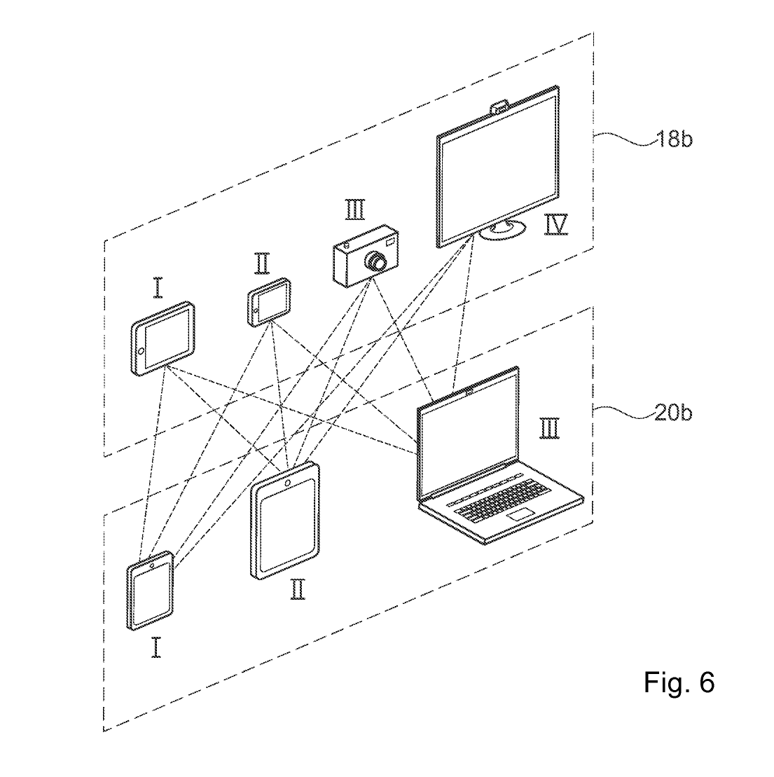

In FIGS. 6 to 8 further exemplary embodiments of the invention are shown. The following descriptions and the drawings are substantially limited to the differences between the exemplary embodiments, wherein regarding identically designated components, in particular components with the same reference numerals, principally the drawings and/or description of the other exemplary embodiments, in particular of FIGS. 1 to 5, may be referred to. For distinguishing the exemplary embodiments from each other, the letter a is put after the reference numerals of the exemplary embodiment in FIGS. 1 to 5. In the exemplary embodiments of FIGS. 6 to 8, the letter a has been substituted by the letters b to d.

In FIG. 6 further possible system configurations of a system 10b, which is provided to carry out the method for recording and processing at least one video sequence 16a comprising at least one video track 12a and a sound track 14a, which is described in the first exemplary embodiment, are shown with different video recording devices 18b I-IV and different operating devices 20b I-III. Any combinations of the video recording devices 18b I-IV and of different operating devices 20b I-III are possible. The person having ordinary skill in the art may apply further suitable apparatuses as video recording devices 18b and operating devices 20b.

A first video recording device 18b I is embodied as a tablet computer and corresponds to the video recording device 18a of the first exemplary embodiment.

A further suggested video recording device 18b II is embodied as a smartphone. The video recording device 18b II is smaller than the video recording device 18b I and can thus be positioned easier.

A further suggested video recording device 18b III is embodied as a digital camera having a function for recording video signals as well as a wireless data interface. Digital cameras usually have a planar underside which is implemented parallel to an optical axis of an objective of the digital camera. The video recording device 18b III can thus be positioned particularly easily by positioning it on a horizontal plane with its underside. A set-up angle of the video recording device 18b III is in this case close to advantageous 0°. Measuring and/or signaling the set-up angle can be dispensed with.

A further suggested video recording device 18b IV is embodied as a smart TV comprising a webcam. The video recording device 18b IV has an especially large screen that implements an effective light source for illuminating a subject recording location. Moreover the video recording device 18b IV comprises a stand support ensuring a set-up angle close to advantageous 0°.

A first operating device 20b I is embodied as a smartphone and corresponds to the operating device 20a of the first exemplary embodiment.

Another suggested operating device 20b II is embodied as a tablet computer. The operating device 20b II is larger than the operating device 20b I and has in particular a larger screen. The larger screen is advantageous in particular in a connection with the video recording device 18b III, which does not comprise a screen oriented to the subject recording location. The system 10b can present all the information relevant for a user particularly clearly on the large screen of the operating device 20b II.

A further suggested operating device 20b III is embodied as a laptop computer. The operating device 20b III has a particularly large amount of computing power and can particularly quickly execute a controlling program that controls a method for recording and processing a video sequence and/or for generating a video film. In particular, effort-intensive processing steps of video sequences can be computed by the operating device 20b III. A screen of the operating device 20b III is particularly suitable for an illumination of the subject recording location.

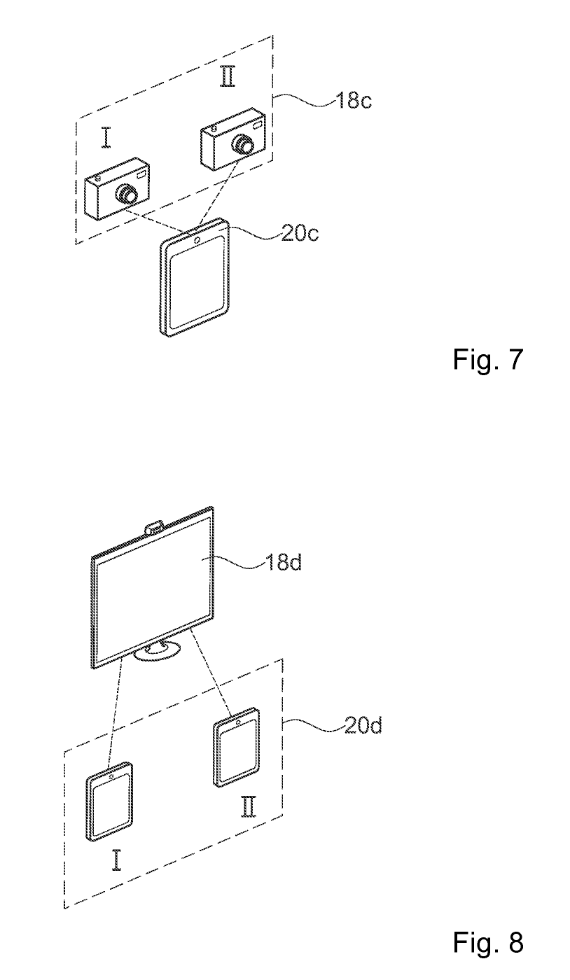

FIG. 7 shows a further possible system configuration of a further system 10c. The system 10c comprises two video recording devices 18c I-II, which are embodied as digital cameras. It is also conceivable to use differing types of video recording devices. The system 10c further comprises an operating device 20c, which is embodied as a smartphone. Due to using two video recording devices 18c I-II, a particularly broad section of a subject recording location can be recorded and/or differing perspectives can be realized in the recording of the subject recording location. This allows a particularly flexible, diversified image design of recorded video sequences.

FIG. 8 shows a further possible system configuration of a further system 10d. The system 10d comprises two operating devices 20d I-II, which are embodied as smartphones. It is also conceivable to use differing types of operating devices. The system 10d further comprises a video recording device 18d, which is implemented as a smart TV. For a sound recording, microphones of both operating devices 20c I-II are used. The sound recording with two microphones allows a particularly high sound quality.

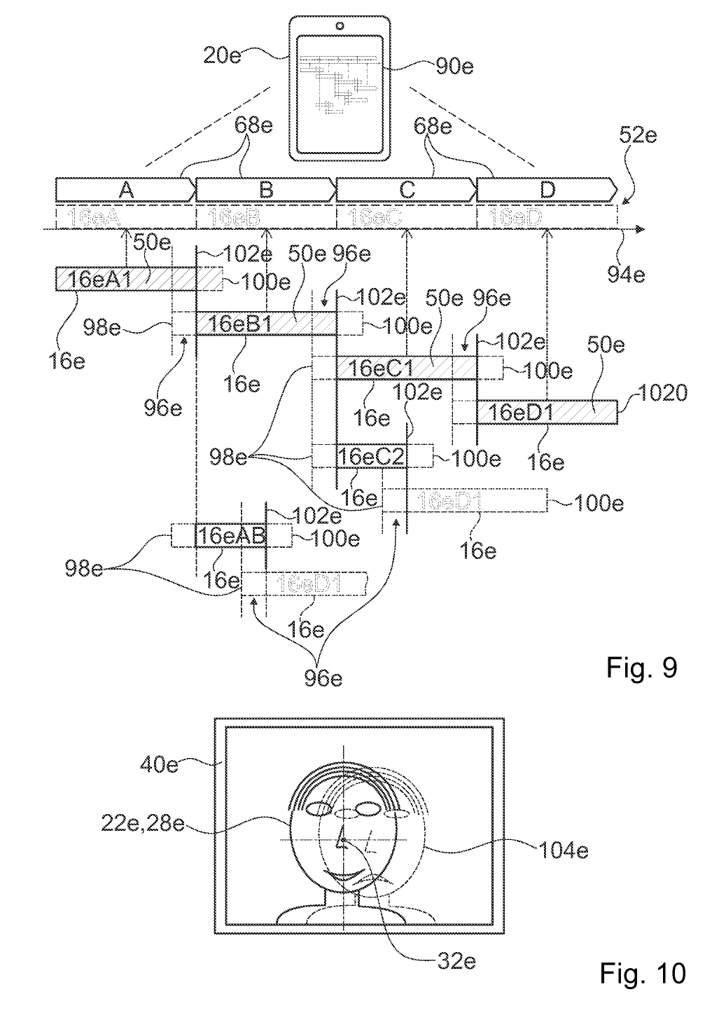

FIG. 9 shows a presentation of a further method for sequentially recording and/or processing video sequences 16e. This method is also executed by a controlling program 66e and can be called up by a user 28e. The method differs from the preceding methods in particular in that the video sequences 16e of a video film 52e are recorded such that they overlap iteratively along a narrative line 94e. The video film 52e in the example shown comprises four scenes 68e each having different contents, which are in the example designated by A, B, C and D. For example, in a video film 52e, which is intended for a job application, a first scene A can comprise a general introduction of the user 28e, a second scene B comprises a curriculum vitae of the user 28e, a third scene C comprises a requirement profile of a job position the user 28e is searching for, and a fourth scene D comprises a final conclusion of the user 28e. Depending on a planned utilization of the video film 52e, differing scenes 68e are possible, which are suggested to the user 28e in form of scripts.

First of all, a video sequence 16eA1 is recorded, which comprises a first shot of scene A, then a video sequence 16eB1 is recorded with a first shot of scene B, a video sequence 16eC1 is recorded with a first shot of scene C and a video sequence 16eD1 is recorded with a first shot of scene D. The video sequences 16eA1 to 16eD1 respectively comprise overlap regions 96e, which have identical contents. The overlap regions 96e respectively start at a start point 98e, at which a recording of the following video sequence 16e starts, and respectively end at an end point 100e, at which the recording of the current video sequence 16e is cut off. Due to the overlapping contents of the video sequences 16e, it is possible to vary, within the overlap region 96e, a cut mark 102e, at which between one video sequence 16e and the next one a cut is set when the video film 52e is put together. Due to the overlap regions 96e, a further video sequence 16e is also particularly easily recordable as the user 28e is shown the preceding video sequence 16e together with a countdown up to the end point 100e, at which the video sequence 16e is cut off. Advantageously, for orientation, an already recorded sound track 14e can also be played to the user 28e besides the video sequence 16e. Furthermore, a contextual overlay 104e is advantageously shown to the user 28e on a screen 40e (FIG. 10). The contextual overlay 104e is a ghost-like video image laid over a currently recorded video signal 22e, showing contours of an already recorded video sequence 16e, e.g. in particular a contour of the user 28e. The user 28e advantageously realizes which position to take for ensuring a cut to the already recorded video sequence 16e that is as seamless as possible. The contextual overlay 104e is shown statically to show the user 28e a position he is to assume, or dynamically, i.e. such that it is moving and shows the contours of the already recorded video sequence 16e, to make it easier for the user to adapt to the preceding recording when doing a new recording. Preferably the user 28e is shown how well his subject position 32e, his body posture, gesturing and/or facial expression is adapted to the already recorded video sequence 16e. This is indicated by the contextual overlay 104e changing its color in particular from “red” to “green”, depending on how well the user 28e has adapted subject position 32e, body posture, gesturing and/or facial expression to the already recorded video sequence 16e. The user 28e can now start at any point during the countdown to record the following video sequence 16e, while repeating in the overlap region 96e the content of the preceding video sequence 16e. The user 28e can view the overlap regions 96e of two successive video sequences 16e and can set the cut mark 102e appropriately. Moreover, further shots of scenes 68e can be recorded, in the example a video sequence 16eC2, which comprises a further shot of scene C with an increased speech velocity. If the user 28e selects the video sequence 16eC2, he can temporally shift the already recorded video sequence 16eD1 in such a way that it directly follows the video sequence 16eC2 and a time gap is avoided. Furthermore, the user can record further video sequences 16e, e.g. a video sequence 16eA-B, which is to be inserted subsequently between the video sequences 16eA1 and 16eB1.

During processing the user 28e is shown, on a screen 90e of the operating device 20e, the video sequences 16e along the narrative line 94e according to FIG. 9, such that he can arrange the video sequences 16e to his desire, in the manner described, in case of a screen 90e implemented as a touch screen by direct touch and/or draw and/or drag, and in case of a screen 90e with a mouse-operation by a corresponding manipulation with a mouse cursor. Furthermore, the video sequences 16e are continuously evaluated and an evaluation 50e is indicated to the user 28e, such that the user 28e can consider the evaluation when selecting and arranging the video sequences 16e. In the example the evaluation 50e is embodied such that the video sequences 16e suggested for selection are marked. The indicated evaluation comprises a pre-selection of video sequences 16e suggested for further use. The user 28e can change the pre-selection and/or the indicated evaluation on his part by selecting or discarding the video sequences 16e.

### REFERENCE NUMERALS

10 system
12 video track
14 sound track
16 video sequence
18 video recording device
20 operating device
22 video signal (video device)
24 sound signal (operating device)
26 sound signal (video device)
28 user
30 set-up angle
32 subject position
34 image section
36 set-up location
38 subject recording location
40 screen
42 light source
44 avatar
46 video signal (operating device)
50 evaluation
52 video film
54 tablet computer
56 smartphone
58 computing unit
60 WLAN radio module
62 local network
64 controlling program (video recording device)
66 controlling program (operating device)
68 scene
70 recording room
72 video camera
74 optical axis
76 cut-out
78 control command
80 computing unit (video recording device)
82 template
84 ground
86 video camera (operating device)
88 portion
90 screen (operating device)
92 object
94 narrative line
96 overlap region
98 start point
100 end point
102 cut mark
104 contextual overlay

1. A method for recording and processing at least one video sequence comprising at least one video track and at least one sound track, with at least one video recording device and at least one operating device, wherein primarily a video signal of the video recording device is used for recording the video track of the video sequence, and primarily a sound signal of the operating device is used for recording the sound track of the video sequence.

2. The method according to claim 1, wherein for the recording of the sound track, for suppressing environment noise, a sound signal of the video recording device is processed in addition to the sound signal of the operating device.

3. The method according to claim 1, wherein when the video recording device is set up, a set-up angle of the video recording device is signaled to a user.

4. The method according to claim 1, wherein the video signal of the video recording device is evaluated to the purpose of determining a subject position within an image section.

5. The method according to claim 4, wherein an optimum subject position within the image section is signaled to a user.

6. The method according to claim 1, wherein the video signal of the video recording device is evaluated to the purpose of determining a preferred set-up location of the video recording device and/or a preferred subject recording location.

7. The method according to claim 1, wherein the sound signal of the operating device and/or a sound signal of the video recording device is evaluated to the purpose of determining a preferred set-up location of the video recording device of the video recording device and/or a preferred subject recording location.

8. The method according to claim 1, wherein a screen integrated in the video recording device is used as a light source for illuminating a subject recording location.

9. The method according to claim 1, wherein a user is guided by an avatar during the recording of the video sequence.

10. The method according to claim 1, wherein the video signal of the video recording device and/or a video signal of the operating device is used to identify gestures of a user for controlling the recording of the video sequence.

11. The method according to claim 1, wherein the video sequence is evaluated regarding its impact on beholders, and this evaluation is signaled to a user.

12. The method according to claim 1, wherein when a video film comprising a plurality of recorded video sequences is generated, the video sequences are selected and/or discarded on the basis of an evaluation.

13. A system for generating video sequences and/or video films by a method according to claim 1.

14. The system according to claim 13, wherein the video recording device is embodied as a tablet computer and the operating device is embodied as a smartphone.

15. The system at least according to claim 13, wherein a computing unit of the operating device is provided to control the method for recording and processing the video sequence and/or for generating a video film.

16. The method according to claim 2, wherein
when the video recording device is set up, a set-up angle of the video recording device is signaled to a user.

17. The method according to claim 2, wherein
the video signal of the video recording device is evaluated to the purpose of determining a subject position within an image section.

18. The method according to claim 2, wherein
the video signal of the video recording device is evaluated to the purpose of determining a preferred set-up location of the video recording device and/or a preferred subject recording location.

19. The method according to claim 2, wherein
the sound signal of the operating device and/or a sound signal of the video recording device is evaluated to the purpose of determining a preferred set-up location of the video recording device of the video recording device and/or a preferred subject recording location.

20. The method according to claim 2, wherein a screen integrated in the video recording device is used as a light source for illuminating a subject recording location.
